(19) United States
(12) Patent Application Publication
(10) Pub. No.: US 2008/0034594 A1
(43) Pub. Date: Feb. 14, 2008

(54) Scissors with scales

(76) Inventor: Kuang-Pin Wang, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/503,073

(22) Filed: Aug. 14, 2006

(51) Int. Cl. B26B 13/00

(52) U.S. Cl. 30/233

(57) ABSTRACT

A scissors with scales, including two handles, a pivot member and two blades respectively connected with the handles. The two handles are pivotally connected with each other. Each blade has a blade section having an inner face and an outer face opposite to the inner face. The blade section of one blade has an extension face extending from the inner face to the outer face. The extension face is marked with scales along the blade section.

### BACKGROUND OF THE INVENTION

The present invention is related to a scissors, and more particularly to a scissors with scales.

A scissors is used to scissor a work piece such as a paper. In the case that it is necessary to scissor the paper by a precise length, a user can first visually scissor the paper by a longer length and then measure the length with a ruler and gradually scissor the paper to a predetermined length.

Alternatively, the user can previously measure the length and mark the paper. Then the user scissors the paper along the mark.

With respect to the first scissoring manner, apart of the paper is wasted. In addition, the user needs to repeatedly scissor the paper for achieving a desired length.

With respect to the second scissoring manner, it is necessary to previously mark the paper and then scissor the paper. When marking the paper, it often takes place that the paper is incautiously broken. Also, in the case that the mark is too large or too rough, the paper can be hardly precisely cut.

In addition, it costs more time to scissor the paper in both the above manners. This is inconvenient to the user.

### SUMMARY OF THE INVENTION

It is therefore a primary object of the present invention to provide a scissors with scales. When scissoring a work piece with the scissors, a user can precisely scissor the work piece by a predetermined length without previously measuring and marking the work piece.

According to the above object, the scissors with scales of the present invention includes:

two handles, each handle having a holding section at one end, the other end of the handle having a first fixing section, the first fixing section of at least one of the handles being formed with a through hole;

a pivot member fitted through the through hole of the handle to pivotally connect the two handles with each other; and

two blades respectively connected with the handles, each blade having a second fixing section and a blade section, the second fixing section of the blade being fixed with the first fixing section of the handle, the blade section having an inner face and an outer face opposite to the inner face, the inner faces of the two blades facing each other, the blade section of one blade having an extension face extending from the inner face to the outer face, the extension face being marked with scales along the blade section.

The present invention can be best understood through the following description and accompanying drawings wherein:

### BRIEF DESCRIPTION OF THE DRAWINGS

FIG. 1 is a perspective assembled view of the present invention;

FIG. 2 is a perspective exploded view of the present invention;

FIG. 3 is a perspective exploded view of a second embodiment of the present invention;

FIG. 4 shows the use of the scissors of the present invention;

FIG. 5 is a backview of the blade with the scales of the present invention; and

FIG. 6 shows that the present invention is used to remove a staple.

### DETAILED DESCRIPTION OF THE PREFERRED EMBODIMENTS

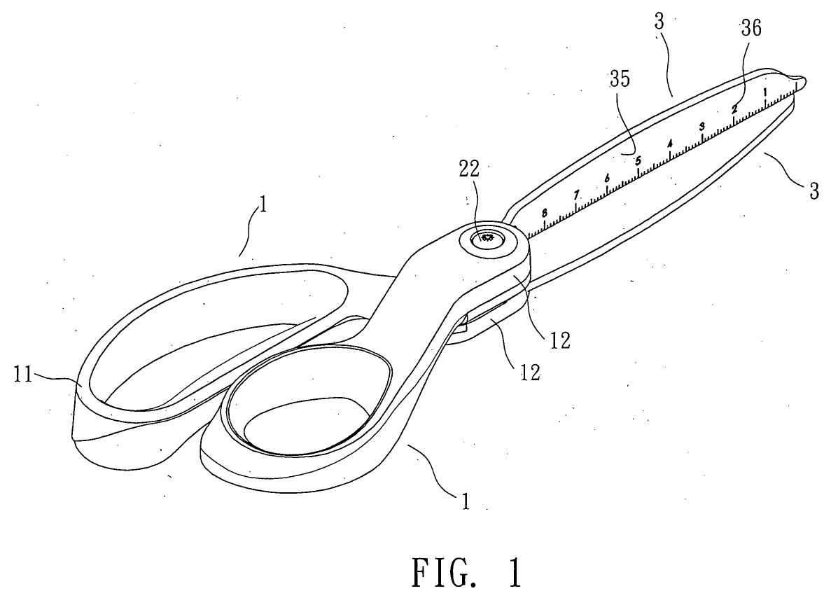

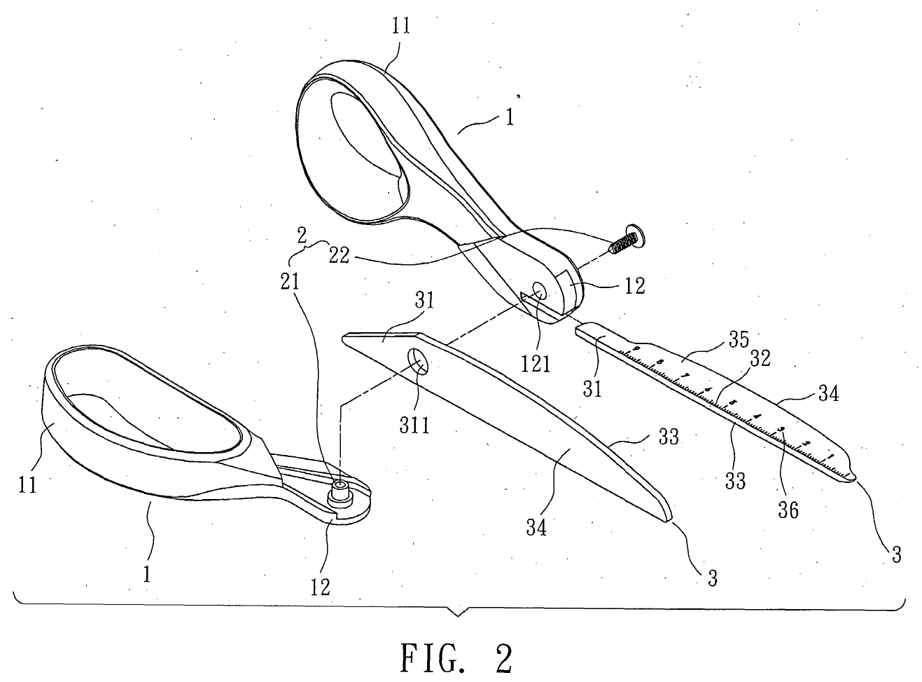

Please refer to FIGS. 1 and 2. The scissors with scales of the present invention includes two handles 1, a pivot member 2 and two blades 3 respectively connected with the handles 1.

Each handle 1 has a holding section 11 at one end. The other end of the handle 1 has a first fixing section 12. The first fixing section 12 of one of the handles 1 is formed with a through hole 121.

The pivot member 2 is fitted through the through hole 121 of the handle 1 to pivotally connect the two handles 1 with each other. In this embodiment, the pivot member 2 includes a pivot shaft 21 and a screwed member 22. The pivot shaft 21 is integrally connected with the first fixing section 12 of the other of the two handles 1. The pivot shaft 21 is fitted through the through hole 121. The screwed member 22 is screwed into the pivot shaft 21 to fix the two handles 1 with each other. Accordingly, the two handles 1 will not detach from each other.

Each blade 3 has a second fixing section 31 and a blade section 32. The second fixing section 31 of the blade 3 is fixed with the first fixing section 121 of the handle 1. The blade section 32 has an inner face 33 and an outer face 34 opposite to the inner face 33. The inner faces 33 of the two blades 3 face each other. The blade section 32 of one blade 3 has an extension face 35 extending from the inner face 33 to the outer face 34. The extension face 35 is marked with scales 36 along the blade section 32.

The first fixing section 12 is formed with an insertion slot. The second fixing section 31 is inserted in the first fixing section 12 to fix the blade 3 with the handle 1. The second fixing section 31 of one of the blades 3 is formed with a fixing hole 311 corresponding to the pivot member 2, whereby the pivot shaft 21 of the pivot member 2 is fitted through the fixing hole 311.

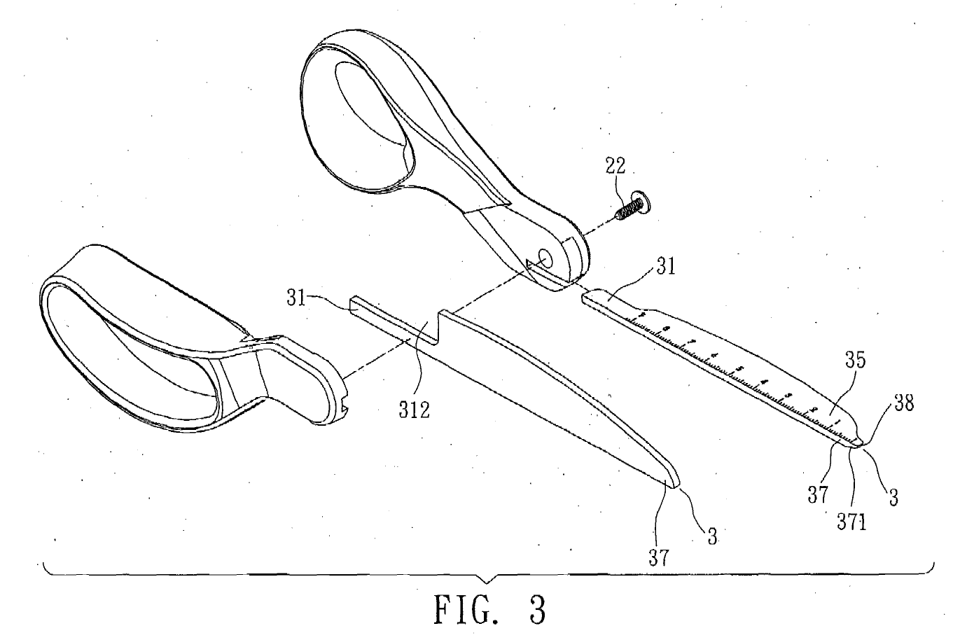

FIG. 3 shows a second embodiment of the present invention, in which the second fixing section 31 of one of the blades 3 is formed with a notch 312 for the pivot member 2 to pass therethrough. (The pivot shaft 21 is not shown.)

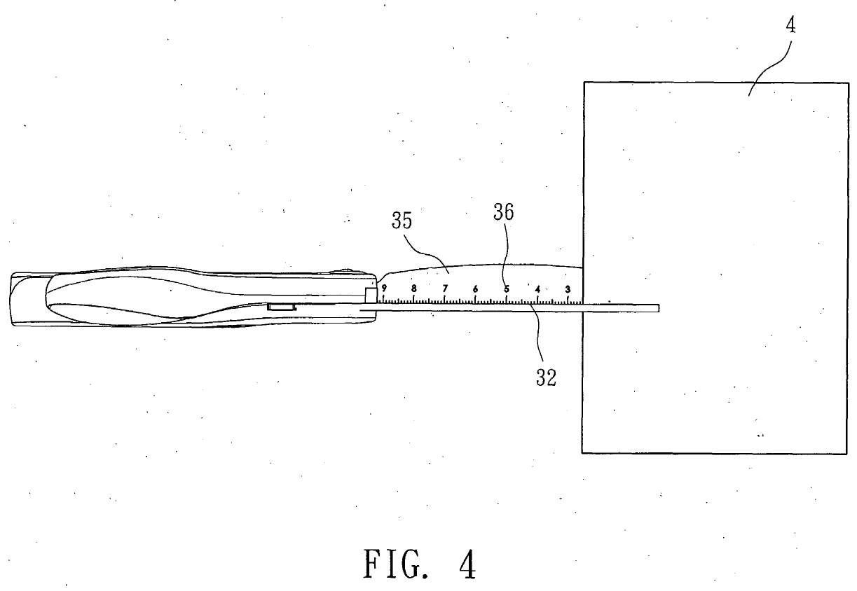

Referring to FIG. 4, when scissoring a paper, the paper is directly placed on the blade and aligned with a predetermined scale 36 (3.5 cm in FIG. 4). Then the scissors is directly used to scissor the paper by a predetermined length.

Accordingly, a user can use the scissors of the present invention to precisely and conveniently scissor the paper by a predetermined length to save time.

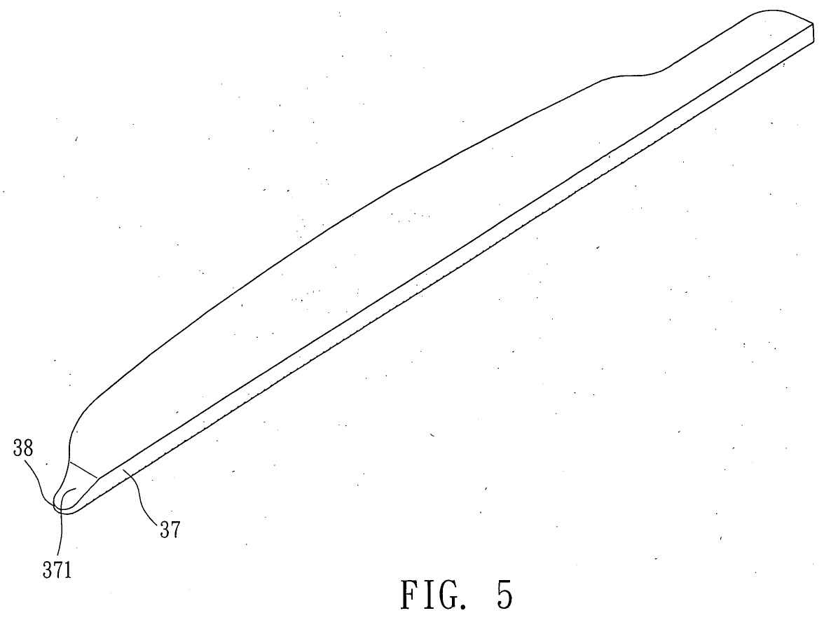

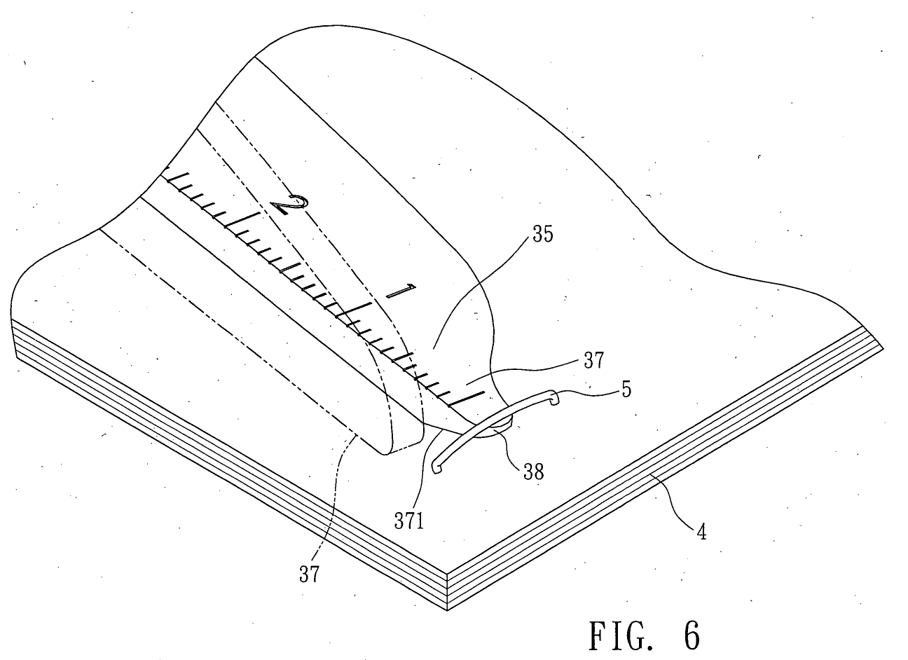

Referring to FIGS. 3, 5 and 6, each blade 3 has an end section 37 distal from the second fixing section 31. The end section 37 of the blade 3 with the extension face 35 has a plane abutting face 371 opposite to the extension face 35. The end section 37 is tapered to form an acute section 38 protruding from the end section 37 of the other blade 3. The abutting face 371 is inclined to the extension face 35.

When removing a deflected staple 5, the acute section 38 can be inserted into the gap between the paper and the staple 5 to lift and remove the staple 5.

The above embodiments are only used to illustrate the present invention, not intended to limit the scope thereof. Many modifications of the above embodiments can be made without departing from the spirit of the present invention.

What is claimed is:

1. A scissors with scales, comprising:
two handles, each of the handles having a holding section at a first end, a second end of each of the handles having a first fixing section, the first fixing section of at least one of the handles being formed with a through hole;
a pivot member fitted through the through hole of the handle to pivotally connect the two handles with each other; and
two blades respectively connected with the handles, each of the blades having a second fixing section and a blade section, the second fixing section of the blade being fixed with the first fixing section of the handle, each of the blade sections having an inner face and an outer face opposite to the inner face, the inner faces of the two blades facing each other, the blade section of a first blade of the two blades having an extension face extending from the inner face to the outer face thereof, the extension face being marked with scales along the blade section,
wherein each blade has an end section distal from the second fixing section, the end section of the first blade having a plane abutting face located opposite to the extension face, the end section being tapered to form an acute section.
wherein the acute section protrudes from the end section of the first blade, the abutting face inclining toward the extension face.

2. The scissors with scales as claimed in claim 1, wherein the first fixing section of the handle is formed with an insertion slot, the second fixing section of one of the blades being inserted in the first fixing section to fix the blade with the handle.

3. The scissors with scales as claimed in claim 2, wherein the second fixing section of one of the blades is formed with a fixing hole corresponding to the pivot member, whereby the pivot member is fitted through the fixing hole.

4. The scissors with scales as claimed in claim 2, wherein the second fixing section of one of the blades is formed with a notch for the pivot member to pass therethrough.

5-6. (canceled)
